(19) United States
(12) Patent Application Publication
(10) Pub. No.: US 2015/0096888 A1
(43) Pub. Date: Apr. 9, 2015

(54) bG METER LENS ATTACHMENT AND SEAL

(71) Applicant: Roche Diagnostics Operations, Inc., Indianapolis, IN (US)

(72) Inventors: Christopher L. Belisle, Somerset, WI (US); Craig A. Carson, Freemont, CA (US); Robert G. Davies, Carmel, IN (US); Joel S. Gerich, Stillwater, MN (US); Timothy L. Ranney, Lebanon, IN (US)

(73) Assignee: Roche Diagnostics Operations, Inc., Indianapolis, IN (US)

(21) Appl. No.: 14/047,220

(22) Filed: Oct. 7, 2013

(51) Int. Cl. G01N 27/327

(52) U.S. Cl. CPC G01N 27/3271
USPC 204/403.02; 204/403.01

(57) ABSTRACT

A blood glucose test device with viewing lens seal includes a meter body rigid portion of a first polymeric material and an opening. A resilient portion of a second polymeric material more compressible than the first polymeric material integrally connected to the rigid portion defines a rigid portion outer covering. A resilient portion edge extends beyond the rigid portion and partially into the opening about a perimeter of the opening. A transparent polymeric material lens has an outer perimeter surface in contact with the resilient portion edge. Multiple flexible arms extending from the lens each have a hook member. Each hook member engages a receiving member positioned in a meter body and is retained by multiple backup ribs. Hook member engagement at a locking position pulls the lens toward the edge partially compressing the second polymeric material and creating a fluid seal between the perimeter surface and edge.

### FIELD

The present disclosure relates to a system and method for attaching and sealing a lens to a blood glucose measurement meter.

### BACKGROUND

This section provides background information related to the present disclosure which is not necessarily prior art.

Medical devices are used as diagnostic devices and/or therapeutic devices in diagnosing and/or treating medical conditions of patients. For example, a blood glucose meter is used as a diagnostic device to measure blood glucose levels of patients suffering from diabetes. Blood glucose meters use a test strip that receives a patient blood sample. Test strip electrical contacts are electrically contacted when the test strip is inserted into the meter. The meter determines a blood glucose level by measuring currents passed through strip electrical contacts, and provides glucose level readout.

Known meters provide a lens made of a transparent or semi-transparent polymeric material through which a digital display of the glucose level is presented to the user. Additional digital information as well as digital and/or manual buttons can also be provided with the meter to select functions, select alternate display data, eject the test strip, and the like. The lens of known meters is directly abutted to the rigid body of the meter, which does not always seal the meter internal components from moisture or dirt in the environment of use. A simple gasket positioned at the contact area requires a different part and a shelf adapted to receive the gasket, increasing meter complexity, assembly steps and cost.

### SUMMARY

This section provides a general summary of the disclosure, and is not a comprehensive disclosure of its full scope or all of its features.

According to several aspects, a blood glucose test device with viewing lens seal includes a meter body rigid portion of a first polymeric material and an opening. A resilient portion of a second polymeric material more compressible than the first polymeric material integrally connected to the rigid portion defines an outer covering. A resilient portion edge extends beyond the rigid portion and partially into the opening about a substantial portion of a perimeter of the opening. A transparent polymeric material lens has an outer perimeter surface in contact with the resilient portion edge. Multiple flexible arms integrally connected to the lens each have a hook member. Each hook member engages a receiving member positioned in a meter body receiving aperture. Hook member engagement at a locking position pulls the lens toward the edge partially compressing the second polymeric material and creating a fluid seal between the perimeter surface and edge.

According to other aspects, a blood glucose test meter viewing lens seal device includes a blood glucose test meter having a meter body with: a first body portion of a first substantially rigid polymeric material; a second body portion connected to the first body portion; a circuit board having a processor and a test strip receiving member mounted thereto, the circuit board positioned between the first body portion and the second body portion; a resilient body portion of a second compressible polymeric material integrally connected to the first body portion and defining an outer perimeter covering for the first body portion; and an edge of the resilient body portion extending beyond the first body portion thereby defining a perimeter of an opening of the meter body. A lens of a transparent polymeric material is positioned at the opening of the meter body. The lens has an outer perimeter surface entirely in direct contact with the edge of the resilient portion such that the lens completely covers the opening of the meter body. Multiple flexible arms are integrally connected to the lens each having a hook member. The hook member engages a receiving member in each of multiple receiving apertures created in the meter body. Engagement of each hook member with one of the receiving members at a locking position partially compresses the second polymeric material at the edge thereby creating a fluid seal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front left perspective view of a blood glucose meter having a meter lens attachment and seal of the present disclosure;

FIG. 2 is a front left perspective exploded assembly view of the meter lens of FIG. 1 separated from the meter body;

FIG. 3 is a top plan view of the blood glucose meter of FIG. 1;

FIG. 4 is a cross sectional end elevational view taken at section 4 of FIG. 3;

FIG. 5 is a bottom plan view of the lens of FIG. 2;

FIG. 6 is a side elevational view of the lens of FIG. 5;

FIG. 7 is a bottom plan view of the blood glucose meter upper portion of FIG. 1;

FIG. 8 is an end elevational view at area 8 of FIG. 4; and

FIG. 9 is an assembly view of the blood glucose meter of FIG. 1.

Corresponding reference numerals indicate corresponding parts throughout the several views of the drawings.

### DETAILED DESCRIPTION

Example embodiments will now be described more fully with reference to the accompanying drawings.

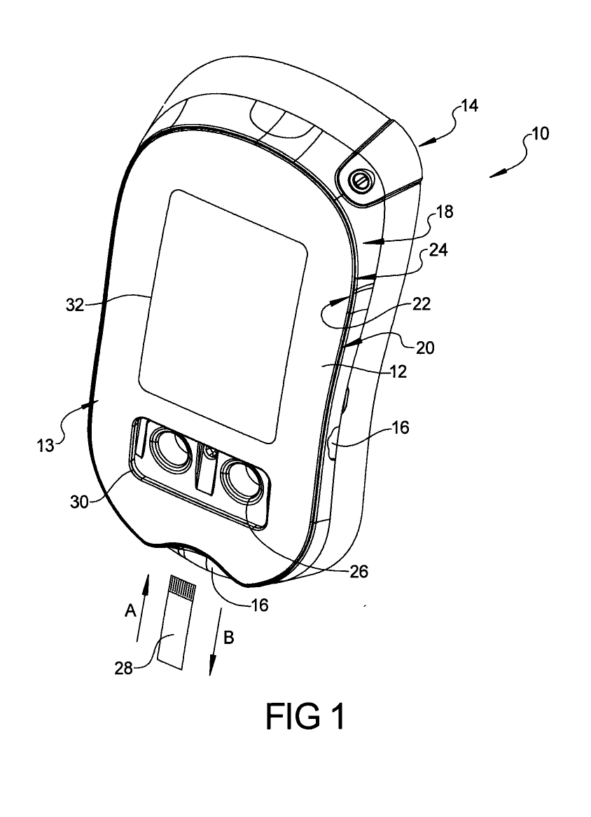

Referring to FIG. 1, an analysis device 10 shown as an exemplary blood glucose test meter can be used for example for testing blood glucose levels. Analysis device 10 includes a viewing lens 12 through which a digital readout provided such as via a liquid crystal display (LCD) visually indicates the results of a body fluid test conducted by analysis device 10. Viewing lens 12 is mounted over and substantially covers an opening 13 of a meter body 14. Meter body 14 includes a rigid portion 16 defining a first body portion molded or formed of a first polymeric material which can be a rigid polymeric material. A resilient portion 18 of a compressible second polymeric material which is different from the first polymeric material and is more compressible than the first polymeric material is integrally connected to the rigid portion 16 of meter body 14. Resilient portion 18 provides as a first function an outer perimeter friction grip cover for meter body 14 to aid the user in holding meter body 14. An edge 20 of the resilient portion 18 extends beyond the rigid portion 16 and partially into the opening 13 of the meter body 14. Substantially all of a perimeter surface 22 of the lens 12, except where proximate to the receiving area of test strip 28, directly contacts the edge 20 of the resilient portion 18 and partially compresses the second material of resilient portion 18 providing a second function of resilient portion 18, to create a fluid seal 24. Resilient portion 18 therefore performs two functions: 1) providing a positive grip surface for the user to hold analysis device 10, and 2) providing an extension acting as a seal surface which therefore obviates the need for an independent gasket part. As used in the above discussion, “substantially” all of the perimeter surface 22 is defined to mean a range including a majority (greater than 90%) up to and including all (100%) of the perimeter surface 22. In the receiving area of test strip 28, the resilient portion 18 may be in direct contact with an undersurface of lens 12 for a short distance in lieu of in contact with the perimeter surface 22, to maintain the fluid seal 24 about the lens 12.

A function button 26 can include the functions of powering on the device, reviewing the memory, setting the time or date, and/or selecting meal markers. The user of analysis device 10 initially inserts a test strip 28 into analysis device 10 in a loading direction “A”. Test strip 28 after being recognized by analysis device 10 is manually removed in a removal direction “B”, dosed, and then reinserted in loading direction “A”. After completion of a test, the test strip 28 is again removed from analysis device 10 by manually pulling the test strip 28 in the removal direction “B”. The function button 26 according to several aspects is a manually depressed button located in a front facing area defined as a function selection section 30 of the meter body 14. Digital data which is generated following the test performed on the fluid sample received with the dosed test strip 28 is displayed in the front facing area of analysis device 10 defined on a data display section 32.

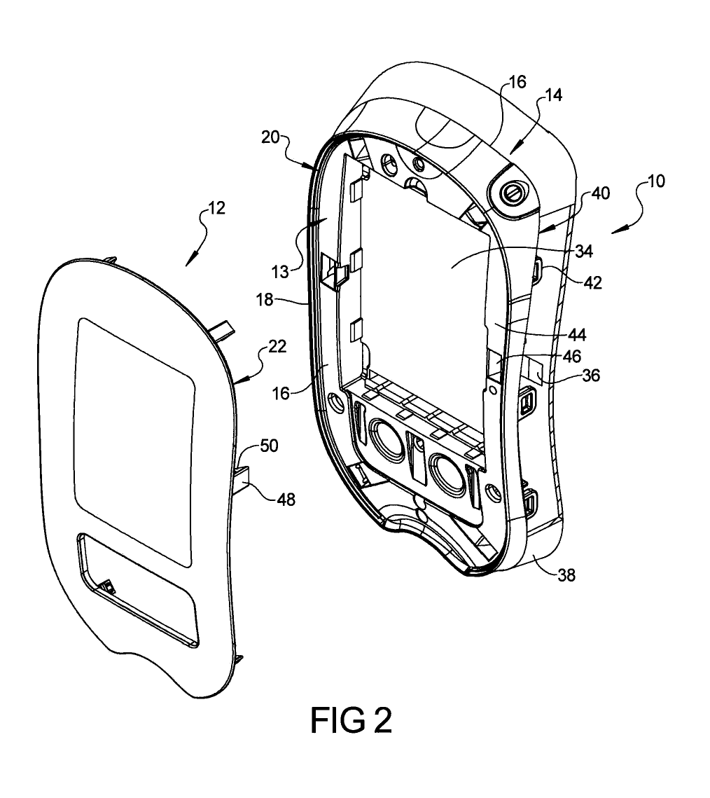

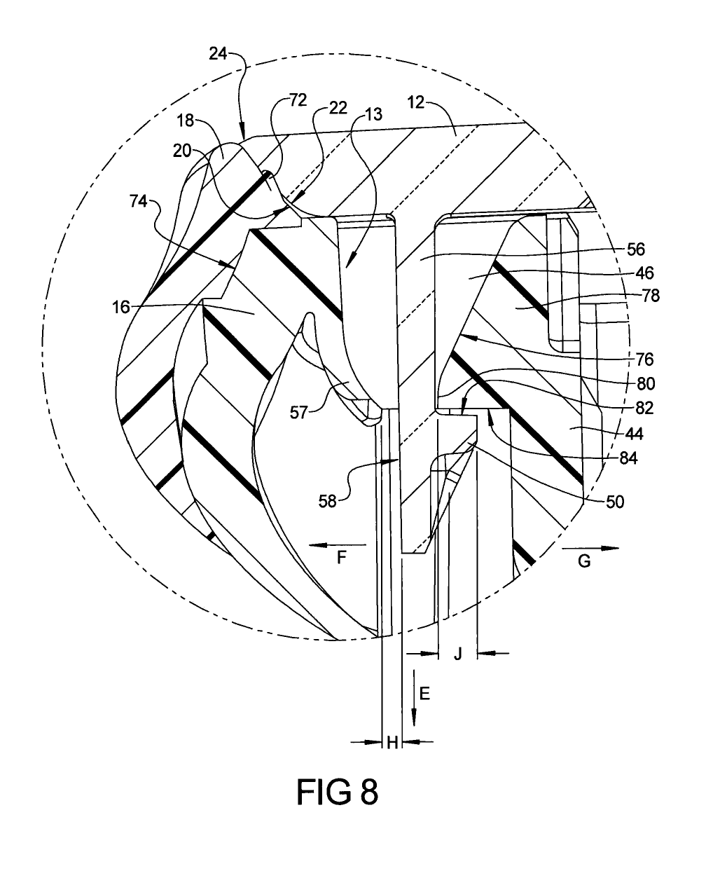

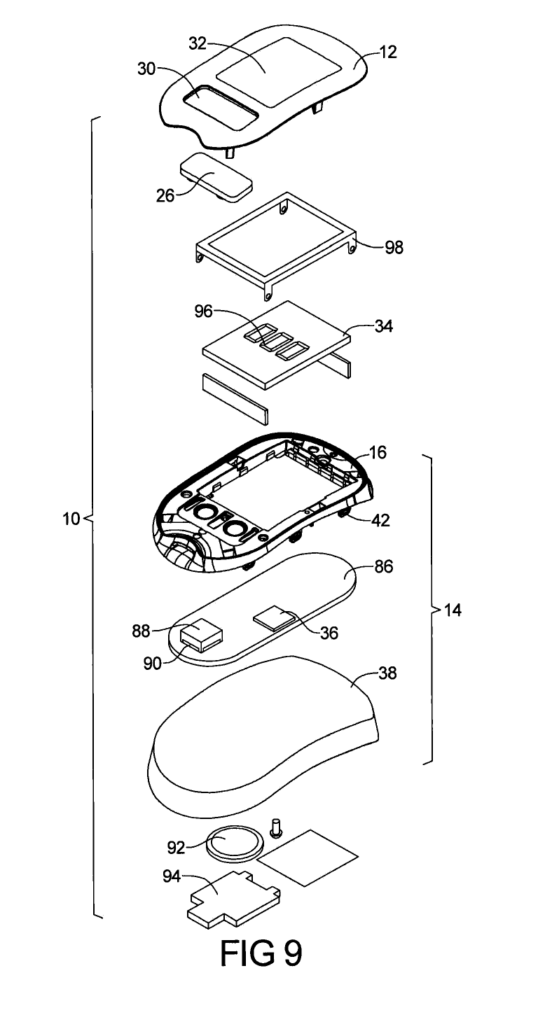

Referring to FIG. 2 and again to FIG. 1, with the lens 12 removed for clarity, a data display board 34 (shown in detail in FIG. 9) is visible in the opening 13. Data display board 34 provides a digital display of the results of a test conducted by a processor 36 and is visible through the data display section 32. A second body portion 38 of meter body 14 is connected at a body connection edge 40 to rigid portion 16. A plurality of flexible connection fingers 42 integrally connected to a panel portion 44 of rigid portion 16 releasably engage the second body portion 38 to rigid portion 16. Panel portion 44 also provides multiple hook member receiving apertures 46. To mount lens 12, lens 12 includes multiple flexible arms, which according to several aspects include six flexible arms 48, each having an integrally connected hook member 50. Individual ones of the flexible arms 48 together with its hook member 50 are inserted into one of the hook member receiving apertures 46 to couple lens 12 to meter body 14 as will be better described in reference to FIG. 8.

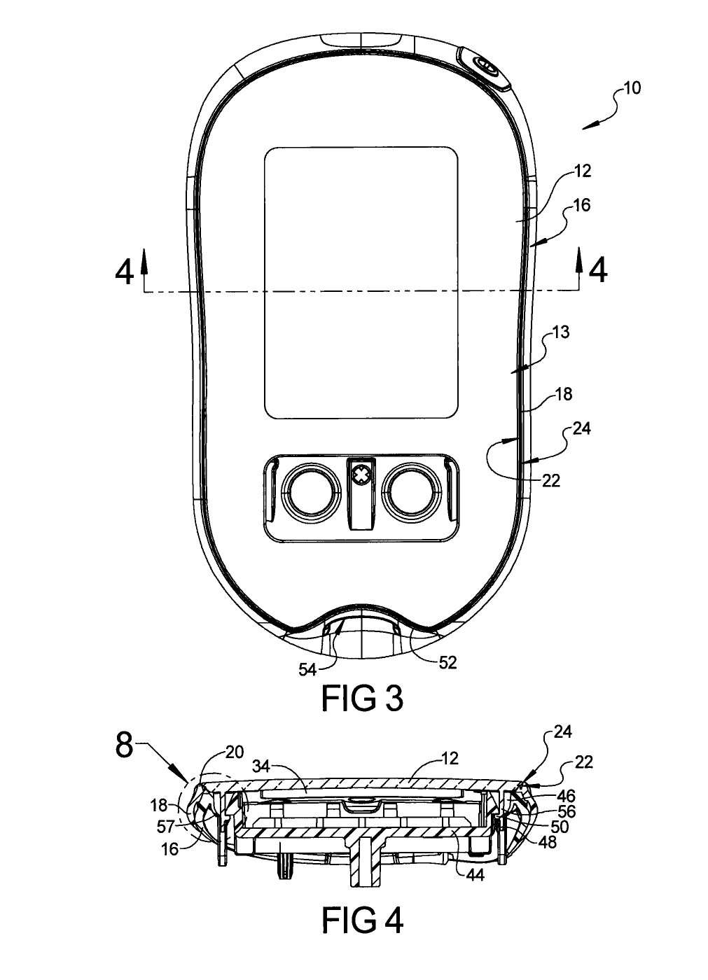

Referring to FIG. 3 and again to FIGS. 1-2, as previously noted the edge 20 of the resilient portion 18 extends beyond the rigid portion 16 and therefore extends partially into the front or viewing opening 13 of the meter body 14. According to several aspects, an entirety of the perimeter surface 22 of the lens 12 contacts the edge 20 of the resilient portion 18 to create fluid seal 24. The geometry of lens 12 can be any geometric shape which conforms to the geometry of meter body 14, and can include a recess or concave area 52 which accommodates access to an inlet port 54 of meter body 14 which receives the test strip 28.

Referring to FIG. 4 and again to FIGS. 1-3, edge 20 provides the contact area for the perimeter surface 22 of lens 12 to partially compress the resilient material of resilient portion 18, thereby creating the fluid seal 24. Each flexible arm 48 that extends from lens 12 includes a flexible beam 56 that is slidably received in one of the hook member receiving apertures 46. The hook member 50 then engages the panel portion 44 in a locked condition to retain the fluid seal 24. Backup ribs 57 are also provided to help retain hook members 50 in their installed and locked positions.

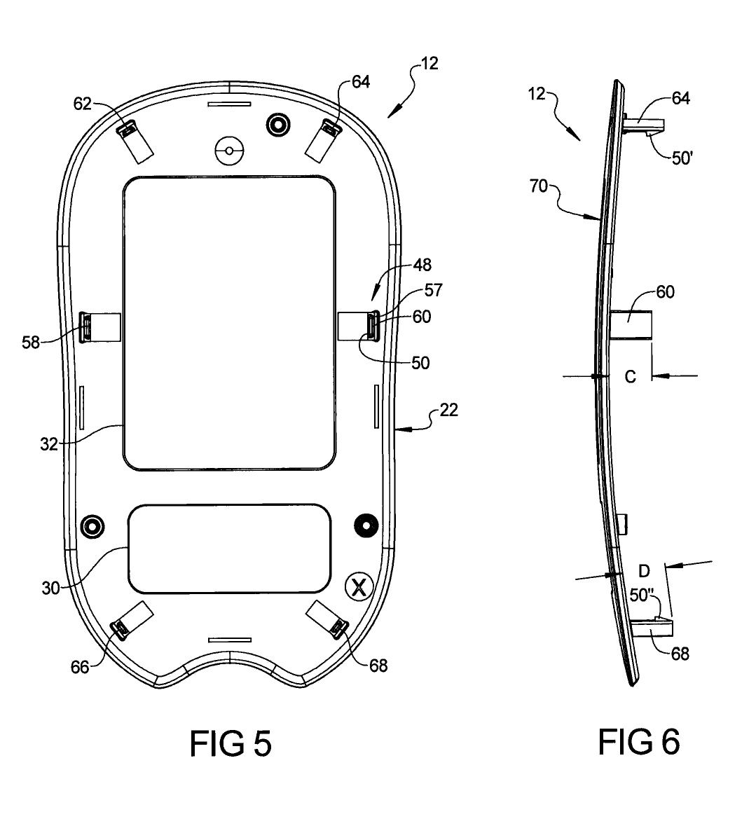

Referring to FIG. 5 and again to FIG. 2, the multiple flexible arms 48 of lens 12, according to one aspect, include six flexible arms. These include first and second flexible arms 58, 60 oppositely positioned about and substantially centered with respect to data display section 32. Third and fourth flexible arms 62, 64 are positioned at corners of lens 12 proximate to data display section 32, and fifth and sixth flexible arms 66, 68 are positioned at opposite corners of lens 12 proximate to function selection section 30. The corner and mid-data display section positioning of the flexible arms balances the pressure applied by lens 12 on the resilient portion 18 to thereby create an even compression of resilient portion 18 about the perimeter of lens 12. To maximize its holding capability, each hook member 50 is oriented substantially parallel to the perimeter surface 22 at the closest point of approach of each flexible arm to the perimeter surface 22. The backup ribs 57 provide additional reinforcement to limit deflection of the hook members 50 when installed.

Referring to FIG. 6 and again to FIG. 5, a height of each of the flexible arms 48 can be equal, or different heights can be used. For example, first and second flexible arms 58, 60 can have a height “C” which can be less than a height “D” of fifth and sixth flexible arms 66, 68. Any geometric shape can be used for lens 12 which matches the geometry of resilient portion 18 and rigid portion 16. According to several aspects, lens 12 has a shape which matches the shape of edge 20 of the resilient portion 18, and has a continuous curving convex shaped outer surface 70. As previously noted, each of the six flexible arms 48 including first, second, third, fourth, fifth and sixth flexible arms 58, 60, 62, 64, 66, 68 have the hook member 50 positioned at a free end of the arm and directed back toward the curved body of lens 12, although this orientation of the hook members 50 is not limiting.

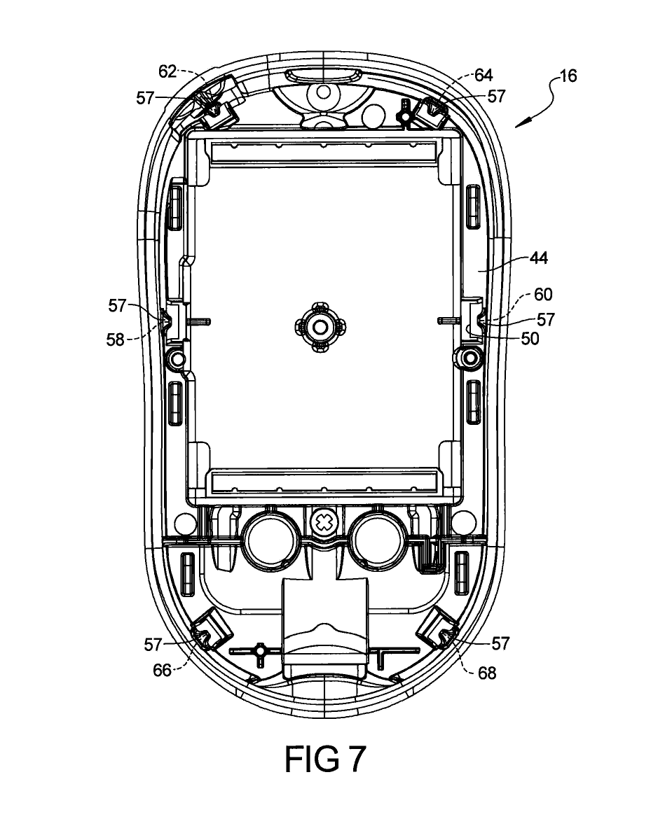

Referring to FIG. 7 and again to FIG. 2, when lens 12 is coupled to the resilient portion 18 which is fixed to rigid portion 16 of meter body 14, one of the backup ribs 57 is positioned proximate to each hook member 50 of the first, second, third, fourth, fifth and sixth flexible arms 58, 60, 62, 64, 66, 68, (shown in phantom) which directly contact an underside (an interior facing side) of the panel portion 44. The first, second, third, fourth, fifth and sixth flexible arms 58, 60, 62, 64, 66, 68 thereby releasably couple lens 12 to rigid portion 16. To release lens 12, each of the hook members 50 are slidably displaced outwardly from their engaged positions.

Referring to FIG. 8 and again to FIGS. 1-4, the edge 20 of the resilient portion 18 extends beyond the rigid portion 16 and its perimeter substantially covers the opening 13 of the meter body 14. According to several aspects, the perimeter surface 22 of lens 12 defines an outwardly directed convex curve. According to several aspects, substantially all or a substantial portion of the perimeter surface 22 of lens 12 directly contacts the edge 20 of the resilient portion 18 and partially compresses the resilient material of resilient portion 18 to create the fluid seal 24. According to other aspects, a portion of the perimeter surface 22 of lens 12 directly contacts the edge 20 of the resilient portion 18 and partially compresses the resilient material of resilient portion 18 to create the fluid seal 24.

A positive engagement surface or web 72 extending from resilient portion 18 folds over when lens 12 contacts resilient portion 18 thereby providing for partial deflection of resilient portion 18 and enhancement of a fluid seal. The resilient portion 18 is fixed to rigid portion 16 at a bonding joint 74 which is created during a second molding operation (such as during a second shot of a two-shot molding process) which creates resilient portion 18 after initial creation of rigid portion 16.

During installation of lens 12, each beam 56 is displaced into one of the hook member receiving apertures 46 in an installation direction “E”. In the exemplary configuration shown, hook member 50 of first flexible arm 58 directly contacts a tapered surface 76 created on an outer wing 78 of panel portion 44 in one of the hook member receiving apertures 46. The hook member 50 slides along tapered surface 76 which elastically deflects beam 56 in an outward deflection direction “F”. Once the hook member 50 extends past a maximum extension point 80 of outer wing 78, hook member 50 rebounds in a return direction ‘G” and the backup ribs 57 thereafter help prevent opposite displacement of hook member 50 in the outward deflection direction “F”. At this time, a coupling surface 82 of hook member 50 contacts a receiving member or receiving member 84 of outer wing 78, which, acting together with backup rib 57 prevents release of lens 12. According to other aspects, the edge 20 of the resilient portion 18 defines an angular surface oriented at a complementary angle with respect to an angle defined by the perimeter surface 22 of the lens 12. According to several aspects, a clearance dimension “H” provided between the backup rib 57 and the flexible arm 58 in the installed condition of lens 12 is less than an overhang or contact dimension “J” of the coupling surface 82 in contact with receiving member 84. Clearance dimension “H” is provided such that flexible arm 58 will be forced to contact the backup rib 57 thereby requiring deflection of beam 56 before the hook member 50 disengages.

Referring to FIG. 9 and again to FIGS. 1-2, analysis device 10 is shown disassembled for clarity. The processor 36 is mounted to a circuit board 86 which is positioned between rigid portion 16 and second body portion 38. A test strip receiving device 88 is also mounted to circuit board 86 which includes a receiving slot 90 that slidably receives and aligns the test strip 28 for testing. A battery 92 providing power for operation of analysis device 10 is mounted to second body portion 38, and is accessible via a removable battery door 94. The data display board 34 can be an LCD board and can provide multiple digital readout LEDs 96 for visually displaying test results at data display section 32. A frame 98 mounts and supports data display board 34 to an external directed side of rigid portion 16. The function button 26 is mounted to the external directed side of rigid portion 16 and is received in function selection section 30.

According to several aspects, the blood glucose test device 10 with a viewing lens seal includes blood glucose test meter body 14. Meter body 14 includes rigid portion 16 of a first polymeric material and the opening 13 and a resilient portion 18 of a second polymeric material more compressible than the first polymeric material. The resilient portion 18 is integrally connected to the rigid portion 16 and defines an outer covering of the rigid portion 16. An edge 20 of the resilient portion 18 extends beyond the rigid portion 16 and partially into the opening 13 about an entire perimeter of the opening 13. The lens 12 is made of a transparent polymeric material having an outer perimeter surface 22 engaged for its entirety to the edge 20 of the resilient portion 18. Multiple flexible arms 48 are integrally connected to the lens 12, each flexible arm 48 having a hook member 50. The hook member 50 engages a receiving member 84 positioned in each of multiple flexible arm receiving apertures 46 created in the meter body 14. Engagement of each hook member 50 with one of the receiving members 84 at a locking position acts to pull the lens 12 toward the edge 20 partially compressing the second polymeric material and thereby creating a fluid seal 24 between the perimeter surface 22 and the edge 20.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A blood glucose test device having a viewing lens seal, comprising:
a blood glucose test meter body, having:
a rigid portion of a first polymeric material and having an opening;
a resilient portion of a second polymeric material more compressible than the first polymeric material, the resilient portion integrally connected to the rigid portion and defining an outer covering of the rigid portion; and
an edge of the resilient portion extending beyond the rigid portion and partially into the opening about substantially all of a perimeter of the opening;
a lens of a transparent polymeric material having an outer perimeter surface in contact with the edge of the resilient portion; and
multiple flexible arms integrally connected to the lens, each arm having a hook member, the hook member engaging a receiving member positioned in each of multiple receiving apertures created in the meter body, engagement of each hook member with one of the receiving members at a locking position operating to pull the lens toward the edge partially compressing the second polymeric material and thereby creating a fluid seal between the perimeter surface and the edge.

2. The blood glucose test device having a viewing lens seal of claim 1, wherein the edge includes an angular surface defining a complementary angle with an angle of the perimeter surface of the lens.

3. The blood glucose test device having a viewing lens seal of claim 1, wherein the lens includes an aperture receiving a data display screen of the medical test meter when the second polymeric material is partially compressed.

4. The blood glucose test device having a viewing lens seal of claim 1, wherein the resilient portion further defines an outer perimeter surface of the meter body.

5. The blood glucose test device having a viewing lens seal of claim 1, further including a data display board providing a digital display of the results of a test conducted by a processor, the data display board being visible through a data display section of the lens.

6. The blood glucose test device having a viewing lens seal of claim 1, wherein the lens includes a front facing area of the meter body defining a function selection section separated from a data display section of the meter body.

7. The blood glucose test device having a viewing lens seal of claim 1, wherein the resilient portion includes a web integrally extending from the edge of the resilient portion which deflects when in contact with the outer perimeter surface of the lens.

8. The blood glucose test device having a viewing lens seal of claim 1, wherein each of the flexible arms includes a beam elastically deflected in an outward deflection direction during installation of the lens onto the edge.

9. The blood glucose test device having a viewing lens seal of claim 1, further including:
a processor connected to a circuit board, the circuit board connected to the rigid portion;
a data display providing a digital display of the results of a test conducted by the processor; and
a frame, the frame connected to the data display and sandwiching the rigid portion.

10. The blood glucose test device having a viewing lens seal of claim 9, further including:
a second body portion connected to the rigid portion having the circuit board positioned between the second body portion and the rigid portion; and
a battery powering the glucose test meter connected to the second body portion.

11. A blood glucose test device having a viewing lens seal, comprising:
a blood glucose test meter including:
a meter body having:
a first body portion of a first substantially rigid polymeric material having an opening;
a second body portion connected to the first body portion;
a circuit board having a processor and a test strip receiving member mounted thereto, the circuit board positioned between the first body portion and the second body portion;
a resilient body portion of a second polymeric material more compressible than the first polymeric material integrally connected to the first body portion and defining an outer perimeter covering for the first body portion; and
an edge of the resilient body portion extending beyond the first body portion and partially into the opening;
a lens of a transparent polymeric material positioned at the opening of the meter body, the lens having an outer perimeter surface in direct contact with the edge resilient body portion edge such that the lens substantially covers the opening; and
multiple flexible arms integrally connected to the lens each having a hook member, the hook member engaging a receiving member in each of multiple receiving apertures created in the meter body, engagement of each hook member with one of the receiving members at a locking position operating to partially compress the second polymeric material at the edge thereby creating a fluid seal between the perimeter surface and the edge.

12. The blood glucose test device having a viewing lens seal of claim 11, wherein each of the flexible arms includes a flexible beam displaced into one of the receiving apertures in an installation direction.

13. The blood glucose test device having a viewing lens seal of claim 12, wherein the hook member is connected to the flexible arm, the hook contacting a tapered surface created on an outer wing of a panel portion of the first body portion to thereby deflect the flexible arm.

14. The blood glucose test device having a viewing lens seal of claim 13, wherein the hook member slides along the tapered surface to elastically deflect the flexible arm in an outward deflection direction until the hook member extends past a maximum extension point of the outer wing, the hook member thereafter rebounding in a return direction.

15. The blood glucose test device having a viewing lens seal of claim 13, further including a backup rib integrally connected to the first body portion and directed toward the hook member, wherein after rebounding in the return direction, a coupling surface of the hook member contacts an engagement surface of the outer wing and the backup rib is positioned proximate to the hook member opposite to the coupling surface preventing release of the lens.

16. The blood glucose test device having a viewing lens seal of claim 11, further including a web integrally extending from the edge of the resilient portion, the web deflected when contacted by the outer perimeter surface of the lens.

17. The blood glucose test device having a viewing lens seal of claim 11, wherein the lens has a continuous curving convex shaped outer surface.

18. The blood glucose test device having a viewing lens seal of claim 11, wherein substantially all of the perimeter surface of the lens directly contacts the edge of the resilient portion and partially compresses the resilient material of the resilient body portion to create the fluid seal.

19. The blood glucose test device having a viewing lens seal of claim 11, wherein a portion of the perimeter surface of the lens directly contacts the edge of the resilient body portion and partially compresses the resilient material of the resilient body portion to create the fluid seal.

20. The blood glucose test device having a viewing lens seal of claim 11, wherein the lens includes a concave area providing access to an inlet port of the meter body aligned with the test strip receiving member to slidably receive the test strip.
